(19) United States
(12) Patent Application Publication
(10) Pub. No.: US 2014/0120014 A1
(43) Pub. Date: May 1, 2014

(54) Device for the Purification of Exhaust Gases from a Heat Engine, Comprising a Ceramic Carrier and an Active Phase Chemically and Mechanically Anchored in the Carrier

(71) Applicants: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Sebastien Goudalle, Sens (FR); Claire Bonhamme, Panazol (FR)

(72) Inventors: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Sebastien Goudalle, Sens (FR); Claire Bonhamme, Panazol (FR)

(73) Assignees: L'Air Liquide Societe Anonyme pour L'Etude Et L'Exploitation Des Procedes Georges Claude, Paris (FR); Centre National De La Recherche Scientifique, Paria (FR); Universite De Limoges, Limoges Cedex (FR)

(21) Appl. No.: 14/128,492

(22) PCT Filed: Jun. 8, 2012
(86) PCT No.: PCT/EP2012/060908

§ 371 Date: Dec. 20, 2013

(30) Foreign Application Priority Data
Jun. 27, 2011 (FR) 1155682

(51) Int. Cl. B01D 53/94

(52) U.S. Cl. CPC B01D 53/9454
USPC 423/212; 422/168

(57) ABSTRACT

Device for the purification of exhaust gases from a thermal combustion engine comprising:

one or several ceramic catalyst carriers comprising an arrangement of crystallites of the same size, same isodiametric morphology and same chemical composition, or approximately the same size, same isodiametric morphology and same chemical composition in which each crystallite is in point or quasi-point contact with the surrounding crystallites, and

one or several active phases for chemical destruction of impurities in the exhaust gas comprising metallic particles having chemical interactions with said ceramic catalyst carrier and mechanical anchoring in said catalyst carrier such that coalescence and mobility of each particle are limited to a maximum volume corresponding to the volume of a crystallite of said ceramic catalyst carrier.

The invention relates to a device for the purification of exhaust gases from a thermal combustion engine, commonly called a “catalytic converter”, particularly for an automobile vehicle, device comprising a carrier on which at least one catalyst is deposited for the chemical destruction of impurities in exhaust gases. The function of such a device is to at least partly eliminate the polluting gases contained in the exhaust gases, particularly carbon oxide, hydrocarbons and nitrogen oxides, by transforming them through reduction or oxidation reactions.

In particular, the invention discloses exhaust gas purifying devices comprising ceramic oxide carriers and active metal particles, for which the structural characteristics and anchoring of particles in the carrier improve performances over those of conventional catalyst oxide carriers.

Synergies have been observed between different chemical and petrochemical industrial applications and the operating conditions of an automobile engine. It is observed that the method that uses a temperature and gaseous atmosphere (H₂, CO, CO₂, residual CH₄, H₂O) most similar to the method of an engine operating at full load is the Steam Methane Reforming (SMR) method. This is particularly true for catalytic materials for active phase selection aspects (noble metals, Ni, etc.), for oxide carrier and/or active phase degradation mechanisms, for operating temperature zones (600-1000° C.) and to a certain extent for spatial velocities particularly in the framework of structured SMR reactors-exchangers. The principal consequence is particularly very similar physical degradation phenomena (temperature inducing coalescence of nanoparticles, delamination of deposits, etc.).

A heterogeneous gas-solid catalyst is usually an inorganic material composed of at least one oxide or other ceramic carrier on which several active phases are dispersed that convert reagents into products through repeated and uninterrupted cycles of elementary phases (adsorption, dissociation, diffusion, reaction-recombination, diffusion, desorption). In some cases, the carrier may act not only physically (large porous volume and large BET surface area to improve dispersion of active phases), but also chemically (for example to accelerate adsorption, dissociation, diffusion and desorption of specific molecules). The catalyst participates in conversion by returning to the original state thereof at the end of each cycle throughout the service life thereof. A catalyst modifies/accelerates the reaction mechanism(s) and the associated reaction rate(s) but does not change the thermodynamics.

Access of reagents to active particles must be maximised if the conversion rate by the carried catalysts is to be maximised. We will start by summarising the main steps in a heterogeneous catalysis reaction, to help understand the advantage of a carrier such as that developed herein. A gas composed of molecules A passes through a catalytic bed and reacts on the catalyst surface to form a species B gas.

These various elementary steps are:
a) Transport of reagent A (volume diffusion), through a gas layer as far as the external surface of the catalyst,
b) Diffusion of the species A (volume or molecular diffusion (Knüdsen)), through the porous lattice of the catalyst, as far as the catalytic surface,
c) Adsorption of species A on the catalytic surface,
d) Reaction of A to form B on catalytic sites present on the surface of the catalyst,
e) Desorption of product B from the surface,
f) Diffusion of species B through the porous lattice,
g) Transport of product B (volume diffusion) from the external surface of the catalyst, through the gas layer, as far as the gas flow.

European standard EURO 5 applicable since 1 Sep. 2009 (and shortly EURO 6 that will become applicable on 1 Sep. 2014) obliges motor vehicle manufacturers to limit emissions of toxic gases (CO, NOx, unburned hydrocarbons) drastically. Optimisation of catalytic converters is now largely related to the optimisation of catalysts (efficiency, service life).

As a reminder, a catalytic converter is composed of a stainless steel conversion chamber into which exhaust gases are introduced. These gases pass through a ceramic structure usually composed of an oxide type (cordierite, mullite, etc.) of ceramic honeycomb substrate. A so-called three-way catalyst (TWC) is deposited on the walls of the ceramic substrate (in the form of a honeycomb). The catalyst accelerates the transformation rate of reagents into products. The objective in catalytic converters is to limit emissions of toxic gases (CO, NOx and unburned hydrocarbons) by transforming them mainly into water, CO₂ and nitrogen.

By definition, a three-way catalyst is capable of performing 3 types of reactions simultaneously:
reduction of nitrogen oxides into nitrogen and in carbon dioxide:

2NO+2CO→N₂+2CO₂
oxidation of carbon monoxides into carbon dioxide:

2CO+O₂→2CO₂

and
oxidation of unburned hydrocarbons (HC) into carbon dioxide and water:

4CₓH_{y}+(4x+y)O₂→4xCO₂+2yH₂O

Oxidation reactions (requiring a high partial pressure of oxygen) and reduction reactions (low partial pressure of oxygen) add constraints. They require a very precise quantity of air to be added into the fuel. A lambda probe placed on the exhaust measures the output oxygen quantity. A control loop very precisely controls the air/fuel ratio, keeping it at an ideal value.

Note that:
The catalytic converter is only efficient starting from about 250-300° C. This is why short journeys are problematic.
The following parasitic reaction can occur at high temperatures:

2NO+CO→N₂O+CO₂

The ceramic architectures of catalytic converters for automobile depollution are usually honeycomb substrates and most are composed of cordierite (2 MgO-2 Al₂O₃-5 SiO₂) or mullite. These architectures develop a low specific area (a few m²/g) with a bulk porosity of 20% to 40%.

Oxides are classical active phase carriers: alumina for the thermochemical stability thereof at low temperatures (<800° C.), ceria for the redox properties thereof with oxygen, and zirconia for the chemical affinity thereof with rhodium. For a long time, research to increase the specific area focussed on γ, δ and θ forms of alumina (from 50 to 250 m²/g). Since then, ceria and zirconia carriers developing 20 to 100 m²/g have been made. However, in all cases, the carrier will thermally collapse after a few cycles inducing a drop in the specific surface area, a drop in the porous volume and an acceleration of metallic nanoparticle migration/diffusion/coalescence phenomena. Oxide carriers were stabilised by the addition of elements such as yttrium, gadolinium, lanthanum, etc., in order to minimise these thermal collapse phenomena of oxide carriers under operating conditions. Thus La—Al₂O₃, CeGdO, ZrYO, CeZrYO, etc. are used, which limits thermal collapse but does not minimise metallic particle migration/sintering phenomena.

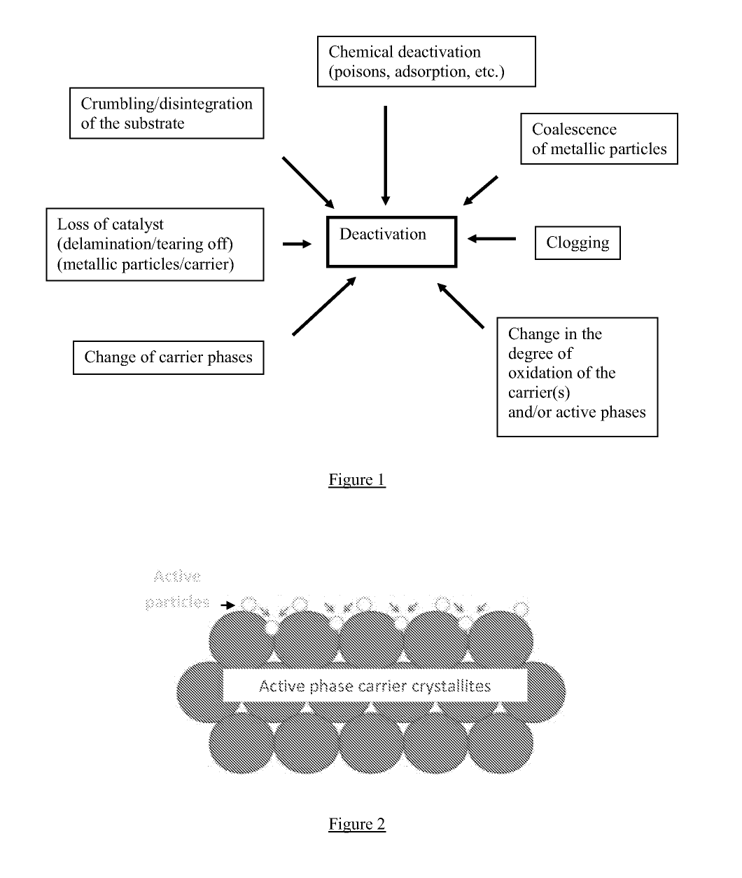

Many studies have been carried out on deactivation of 3-way catalysts, but they do not take account of problems related to properties of the mechanical strength of the cordierite structure (breakage due to vibrations). Deactivation phenomena may be classified as shown in FIG. 1.

Reversible deactivation phenomena occur at low temperatures (<300° C.):
Physisorption of products and reagents, for example CO₂
Chemisorption of products and reagents (for example sulphur oxide on an oxide)

Deactivation phenomena that occur at high temperatures (600-1000° C.) are irreversible and are often reactions between:
Elements of the active phase carrier oxide(s)
Noble metals leading to the formation of unwanted alloys
Noble metals and the active phase oxide carrier (for example migration of the Rh³⁺ ion in a γ Al₂O₃ structure)

However, the phenomena that have the largest impact on performances of high temperature catalysts are (i) sintering of the active phase carrier oxide and (ii) coalescence of active phase metallic particles (nanoparticle diffusion/segregation/coalescence phenomena), the second phenomenon being accelerated by the first, as is the case in the Steam Methane Reforming (SMR) method.

As such, the problem arises of providing a device for purification of exhaust gases from a thermal combustion engine comprising an improved catalyst capable of stabilising active phase nanometric particles under conditions similar to those encountered during steam methane reforming, so as to improve the performances thereof.

One solution according to the invention is a purification device for exhaust gases from a thermal combustion engine comprising:
a ceramic catalyst carrier comprising an arrangement of crystallites of the same size, same isodiametric morphology and same chemical composition, or approximately the same size, same isodiametric morphology and same chemical composition in which each crystallite is in point or quasi-point contact with the surrounding crystallites, and
an active phase for chemical destruction of impurities in the exhaust gas comprising metallic particles mechanically anchored in said catalyst carrier such that coalescence and mobility of each particle are limited to a maximum volume corresponding to the volume of a crystallite of said ceramic catalyst carrier.

The first advantage of the proposed solution concerns the ultra-divided meso-porous ceramic catalyst carrier of the active phase(s). This carrier develops a large available specific area greater than or equal to 20 m²/g, due to the size of the constituent nanometric particles thereof and the arrangement thereof. Furthermore, the carrier is stable under operating conditions of catalytic converters; in other words, the carrier is stable at temperatures of between 600° C. and 1000° C. in an atmosphere containing a mix of exhaust gases (CO, H₂O, NO, N₂, CₓH_{y}, O₂, N₂O . . . ). This thermal stability is directly related to the microstructure of the synthesised material (arrangement of crystallites of the same size, the same isodiametric morphology and same chemical composition, or approximately the same size, the same isodiametric morphology and same chemical composition, in which each crystallite is in point or quasi-point contact with the surrounding crystallites) and related to the associated synthesis method(s).

The particular architecture of the catalyst carrier has a direct influence on the stability of metallic nanoparticles. The arrangement of crystallites and the porosity is sufficient to develop mechanical anchorage of said metallic nanoparticles on the carrier surface.

At the same time, the excellent dispersion of active phases thus obtained can result in a large reduction in the quantity of noble metals used without any loss of catalytic performances.

FIG. 2 shows the mechanical blockage of metallic particles by the ceramic catalyst carrier. Firstly, it is quite clear that the elementary active particles will be no larger than the size of a carrier crystallite. Secondly, the movement thereof under the combined effect of high temperature and a steam-enriched atmosphere is nevertheless limited to the potential wells materialised by the space between two crystallites. The arrows represent the only possible movement of metallic particles.

Finally, note that the mechanical blockage created by the ceramic catalyst carrier limits possible coalescence of the active particles.

Furthermore, the catalyst according to the invention maximises metal/ceramic catalyst carrier interactions.

Chemical bonds between metallic particles and the catalyst carrier are mainly covalent or ionic. Interactions are then electronic. The charge transfer can take place between the metallic atoms of the active phase and oxygen atoms or surface cations of the carrier oxide.

The origin of encapsulation is minimisation of surface energies. This phenomenon takes place when the surface energy of the metal is high and the surface energy of the oxide is low.

FIGS. 3 and 4 show this phenomenon.

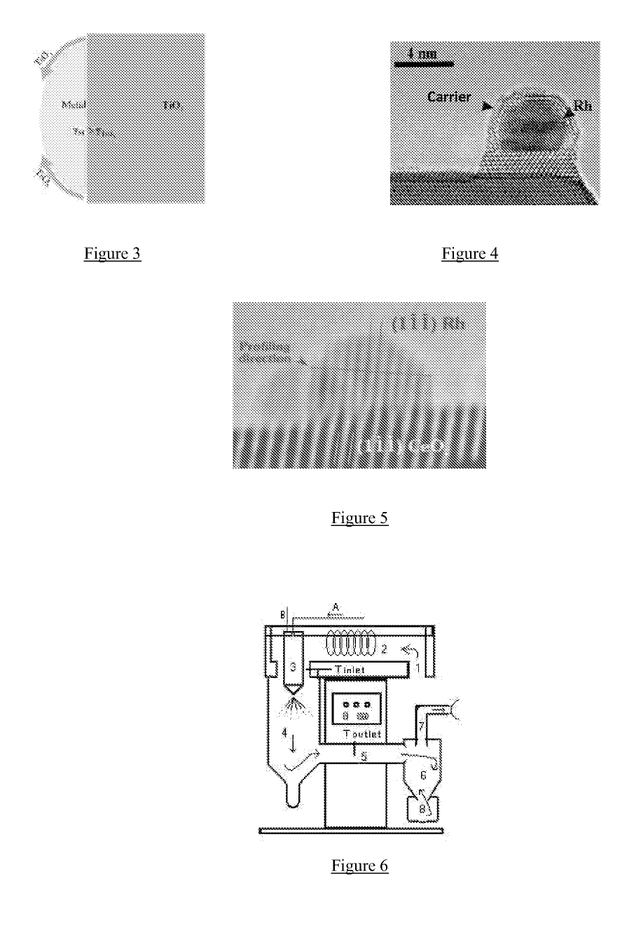

TEM (Transmission Electron Microscopy) photographs show that the crystallites are actually monocrystals. The fact of having a carrier composed of monocrystalline entities introduces the idea of epitaxy type interactions. The use of high resolution transmission electron microscopy makes it possible to observe metal/ceramic catalyst carrier interfaces and thus to conclude that this type of interaction occurs. Note that an epitaxy interaction can occur between two crystalline lattices if they have compatible mesh parameters or symmetries. FIG. 5 shows an epitaxy interaction.

The device according to the invention may have one or several of the following features, depending on the case:
said arrangement is made of alumina (Al₂O₃) optionally stabilised with lanthanum, cerium or zirconium, or made of ceria (CeO₂) optionally stabilised with gadolinium oxide, or made of zirconia (ZrO₂) optionally stabilised with yttrium oxide or made of spinel phase or lanthanum oxide (La₂O₃) or a mix of one or several of these compounds;
metallic particles are chosen from among:
   (i) noble metals chosen from among Ruthenium, Rhodium, Palladium, Silver, Osmium, Iridium, Platinum or an alloy of one, two or three of these noble metals, or
   (ii) transition metals chosen from among Nickel, Silver, Gold, Cobalt and Copper, or an alloy of one, two or three of these transition metals, or
   (iii) an alloy of one, two or three of these noble metals, and one, two or three of these transition metals;
the chemical interaction is chosen between electronic interactions and/or epitaxy interactions and/or partial encapsulation interactions;
the average equivalent diameter of crystallites is between 2 and 20 nm, preferably between 5 and 15 nm, and the average equivalent diameter of metallic particles is between 2 and 20 nm, and preferably less than 10 nm;
the arrangement of active phase carrier crystallites is optimally a compact hexagonal or face-centred cubic stack in which each crystallite is in point or quasi-point contact with not more than 12 other crystallites within a 3-dimensional space.

Preferably, the catalytic (substrate+catalyst) assembly used in the purification device according to the invention may comprise a substrate with various architectures such as cellular structures, drums, monoliths, honeycomb structures, spheres, multi-scale structured reactors-exchangers (μreactors), etc., with a ceramic or metallic or ceramic-coated metallic nature, on which the active phase carrier can be deposited (washcoat).

This invention also relates to a purification method for exhaust gases from a thermal combustion engine in which said exhaust gases are circulated through a device according to the invention.

The thermal combustion engine is preferably an automobile vehicle engine, and particularly a diesel engine or a gasoline engine.

We will now describe in detail how the ceramic carrier-active phase assembly (catalyst) used in the purification device according to the invention is synthesised.

A method for preparing a ceramic carrier-active phase assembly may comprise the following steps:
a) preparation of a ceramic catalyst carrier comprising an arrangement of crystallites with the same size, same morphology and same chemical composition, or approximately the same size, morphology and same chemical composition, in which each crystallite is in point or quasi-point contact with the surrounding crystallites,
b) impregnation of the ceramic catalyst carrier with a precursor solution of the metallic active phase(s);
c) calcination under air of the impregnated catalyst at a temperature of between 350° C. and 1000° C., preferably at a temperature of between 450° C. and 700° C., and even more preferably at a temperature of 500° C. so as to obtain one of the oxidised active phase(s) deposited on the surface of the ceramic catalyst carrier(s); and

d) optional reduction in the oxidised active phase(s) between 300° C. and 1000° C., preferably at a temperature of between 300° C. and 600° C., and even more preferably at a temperature of 300° C.

Note that this method may comprise one or several of the following features:
the impregnation step b) is performed in a vacuum throughout a period of between 5 and 60 minutes;
in step b), the active phase solution is a solution of rhodium nitrate (Rh(NO₃)₃, 2H₂O) or a solution of nickel nitrate (Ni(NO₃)₂, 6H₂O) or palladium nitrate ((Pd(NO₃)₃,2 H₂O) or platinum nitrate ((Pt(NO₃)ₓ),yH₂O) or a mix of these solutions. Carbonate, chloride precursors, etc., or a mix of various precursors (nitrates, carbonates, etc.) containing noble metals (Rh, Pt, Ir, Ru, Re, Pd) and/or transition metals (Ni, Cu, Co, . . . ) may also be used;
after step d), said method may also comprise an aging step e) under operating conditions or conditions similar to operating conditions of the catalyst. The first operating cycle (stop/start) may be considered as an aging step.

The ceramic catalyst carrier described in step a) of the preparation method for the ceramic carrier-active phase assembly used in the purification device according to the invention may be prepared using two methods.

A first method will lead to a ceramic catalyst carrier comprising a substrate and a film on the surface of said substrate comprising an arrangement of crystallites of the same size, same isodiametric morphology and same chemical composition, or approximately the same size, same isodiametric morphology and same chemical composition in which each crystallite is in point or quasi-point contact with the surrounding crystallites.

A second method will lead to a ceramic catalyst carrier containing pellets comprising an arrangement of crystallites of the same size, same isodiametric morphology and same chemical composition, or approximately the same size, the same isodiametric morphology and same chemical composition in which each crystallite is in point or quasi-point contact with the crystallites surrounding it.

Note that the pellets are approximately spherical.

The first method for preparing this ceramic catalyst carrier includes the following steps:
i) Preparation of a sol comprising aluminium and/or magnesium and/or cerium and/or zirconium and/or yttrium and/or gadolinium and/or lanthanum nitrate and/or carbonate salts, a surfactant and solvents such as water, ethanol and ammonia;
ii) Dipping of a substrate into the sol prepared in step i);
iii) Drying of the substrate impregnated with the sol so as to obtain a gelled composite material comprising a substrate covered with a gelled film; and
iv) Calcination of the composite material gelled in step iii) at a temperature typically between 500° C. and 1000° C. in air.

Preferably, the substrate used in this first method for preparation of the ceramic catalyst carrier is made of dense alumina.

The second method for preparation of the ceramic catalyst carrier comprises the following steps:

i) Preparation of a sol comprising aluminium and/or magnesium and/or cerium and/or zirconium and/or yttrium and/or gadolinium and/or lanthanum nitrate and/or carbonate salts, a surfactant and solvents such as water, ethanol and ammonia;

ii) Atomisation of the sol under hot air flow so as to evaporate the solvent and form a micronic powder;

iii) Calcination of the powder at a temperature of between 500° C. and 1000° C.

The sol prepared in the two ceramic catalyst carrier preparation methods preferably comprises four main constituents:
Inorganic precursors: for cost limitation reasons, we have chosen to use magnesium and aluminium, cerium, zirconium, yttrium nitrates or a mix of these nitrate salts. Other inorganic precursors could be used (carbonates, sulphonates, chlorides, etc.) alone or mixed in the method. The stoichiometry of nitrates in the example may be verified by Inductively Coupled Plasma (ICP) before the solubilisation thereof in osmosed water.
The surfactant. A Pluronic F127 triblock copolymer of the EO-PO-EO type could be used. It has two hydrophilic blocks (EO) and a central hydrophobic block (PO).
The solvent (absolute ethanol).
NH₃.H₂O (28% by mass). The surfactant is solubilised in an ammonia solution that creates hydrogen bonds between the hydrophilic blocks and the inorganic species.

The first step consists of solubilising the surfactant (0.9 g) in absolute ethanol (23 mL) and in an ammonia solution (4.5 mL). The mix is then heated under reflux for 1 h. The previously prepared nitrate solution (20 mL) is then added to the mix drop by drop. The whole is heated under reflux for 1 h and is then cooled to ambient temperature. The sol thus synthesised is aged in a ventilated drying oven in which the ambient temperature (20° C.) is precisely controlled.

In the case of the first synthesis method, dipping consists of immersing a substrate into the sol and then removing same at constant speed. The substrates used for our study are alumina plates sintered at 1700° C. for 1 h30 in air (relative density of substrates=97% of the theoretical density). This invention is applicable to substrates with various architectures such as cellular structures, drums, monoliths, honeycomb structures, spheres, multi-scale structured reactors-exchangers (μreactors), etc., of a ceramic or metallic type, or ceramic-coated metallic type, and on which said carrier can be deposited (wash coat).

When the substrate is removed, movement of the substrate entrains the liquid forming a surface layer. This layer separates into two, the inner part moves with the substrate while the outer part drops into the receptacle. Progressive evaporation of the solvent leads to the formation of a film on the surface of the substrate.

The thickness of the deposit obtained can be estimated as a function of the viscosity of the sol and the pulling rate (Equation 1):

e∞κν^{2/3} Equation 1:

where κ is the deposition constant that depends on the viscosity and density of the sol and the liquid-vapour surface tension, and ν is the pulling rate.

Thus, the thickness deposit increases as the pulling rate increases.

The dipped substrates are then oven-dried at between 30° C. and 70° C. for several hours. A gel is then formed. Calcination of the substrates in air can eliminate nitrates and also decompose the surfactant and thus release porosity.

In the case of the second synthesis method, the atomisation technique can transform a sol into a solid dry form (powder) by the use of a hot intermediary (FIG. 6).

The principle is based on spraying fine droplets on the sol 3, in a chamber 4 under a hot air flow 2 in order to evaporate the solvent. The powder obtained is entrained by the heat flux 5 as far as a cyclone 6 that will separate air 7 from the powder 8.

The instrument that can be used within the scope of this invention is a commercial model with the reference “190 Mini Spray Dryer” made by Büchi.

The powder recovered at the end of atomisation is dried in an oven at 70° C. and is then calcined.

Calcination at 900° C. destroys the mesostructure of the deposit that was present at 500° C. Crystallisation of the phase (spinel in this example) leads to local disorganisation of the porosity. Nevertheless, the result is a ceramic catalyst carrier according to the invention, in other words an ultra-divided and highly porous deposit with almost spherical particles in point contact with each other (FIG. 7). FIG. 7 shows 3 high resolution SEM micrographs of the catalyst carrier with 3 different magnifications.

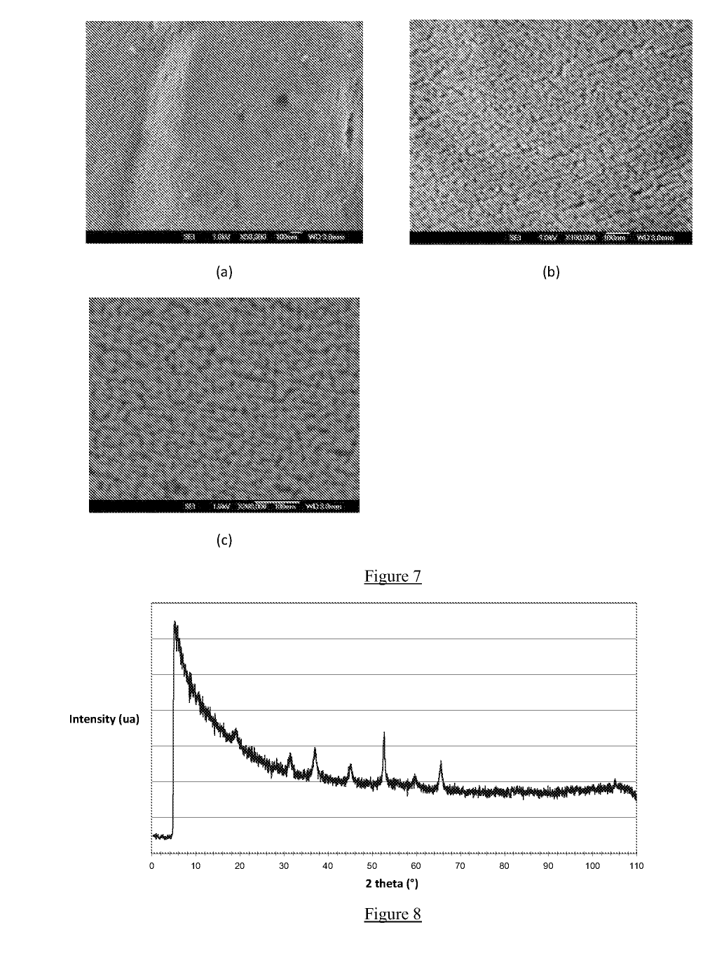

These active phase carrier particles with a size of the order of about ten nanometres have a very narrow size grading distribution centred at about 12 nm. The average size of crystallites, spinel in this example, is 12 nm (measured by small-angle X-ray diffraction, FIG. 8). This size corresponds to the size of elementary particles observed in scanning electron microscopy indicating that elementary particles are monocrystalline.

Small-angle X-ray diffraction (angle 2θ values between 0.5 and 6°): we can use this technique to determine the size of crystallites of the catalyst carrier. The diffractometer used in this study based on a Debye-Scherrer geometry is equipped with a curved position sensitive detector (Inel CPS 120) at the centre of which the sample is placed. The sample is a monocrystalline sapphire substrate on which the sol was dip-coated. The Scherrer formula is used to correlate the width of diffraction peaks at mid-height to the size of the crystallites (Equation 2).

$$D = 0.9 \times \frac{λ}{β cos θ} \qquad Equation 2$$

D is the size of the crystallites (nm)

λ is the wavelength of the Kα line of Cu (1.5406 Å)

β is the width of the line at mid-height (in rad)

θ is the diffraction angle.

In the catalyst preparation method according to the invention, the ceramic catalyst carrier is then impregnated with a solution of Rh, and/or Pt, and/or Pd and/or Ni precursor. The studied catalyst is the three-way catalyst for use in catalytic converters.

Impregnation in the case of an active phase comprising rhodium carried by a spinel carrier (catalyst called AlMg+Rh) is performed in a vacuum for 15 minutes. A nitrate of Rh (Rh(NO₃)₃, 2H₂O) was selected as the inorganic precursor of Rh.

The concentration of Rh in the nitrate solution was fixed at 0.1 g/L. After impregnation, the catalyst is calcined in air at 500° C. for 4 h. At this stage, we have a rhodium oxide deposited on the surface of the ultra-divided mesoporous carrier. The active phase is reduced under Ar—H₂ (3%vol) at 300° C. for 1 h.

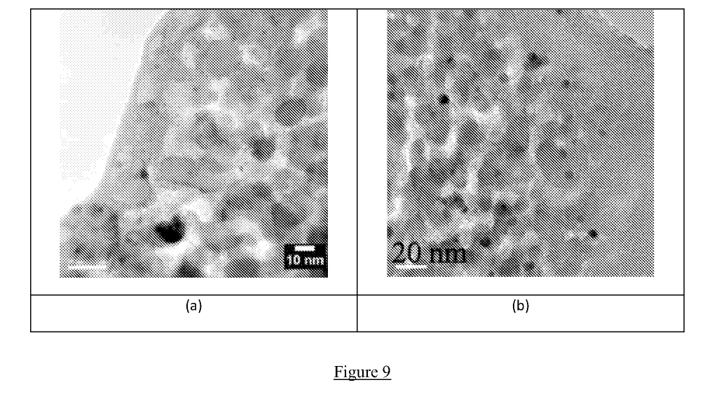

Sizes and metallic dispersion at the carrier surface were observed by transmission electron microscopy (FIG. 9a). These observations reveal the presence of Rh particles in the elementary state with a size of the order of one nanometer. These small particles are concentrated around spinel particles in the carrier.

After aging to simulate the conditions of this catalyst (900° C., 48 h) in a catalytic converter, Rh particles coalesce to a size of 5 nm (FIG. 9b). At this stage, an Rh particle is stabilised on a spinel carrier particle, which strongly reduces the possibility of future coalescence of metallic particles during operation of the catalyst.

In the case of an active phase comprising nickel (catalyst called AlMg+Ni), the carrier is impregnated with a solution of Ni nitrate (Ni(NO₃)₂, 6H₂O). The concentration of Ni in this solution may be fixed at 5 g/L. After impregnation, the catalyst may be calcined in air at 500° C. for 4 h and then reduced under Ar—H₂ (3%vol) at 700° C. for 2 h.

Results similar to those obtained with the AlMg+Rh catalyst are obtained with the AlMg+Ni catalyst.

In the case of active phase(s) comprising rhodium, platinum and palladium (catalyst called AlMg+RhPtPd), the carrier is impregnated with a solution of nitrates containing said elements.

Note that the study for the ultra-divided mesoporous ceramic carrier only concerned spinel (MgAl₂O₄). The two described carrier synthesis methods may for example be extrapolated to ceria optionally doped with gadolinium, or zirconia optionally doped with yttrium oxide.

The catalyst according to the invention was stabilised over time.

The AlMg+Rh catalyst was aged for 20 days, after being exposed to a temperature of the order of 650° C., and another sample was exposed to a temperature of the order of 850° C.

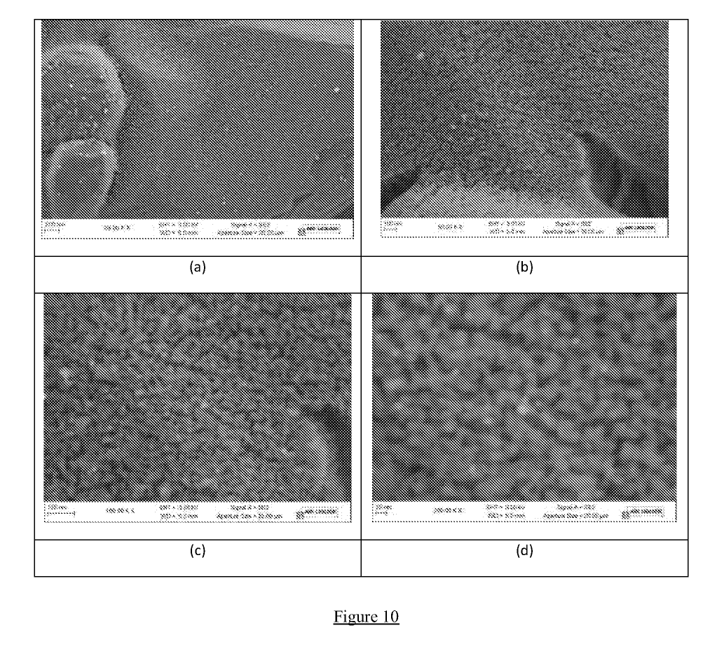

The microstructure of catalysts following aging was observed by scanning electron microscopy. Since the plates for the two temperatures are similar, we will present the characteristics of catalysts exposed to aging at 850° C. (FIG. 10). The atmospheres are very similar to the atmospheres in catalytic converters.

The ultra-divided spinel phase carrier (ceramic catalyst carrier) is preserved after aging and the increase in the size of spinel particles is very limited.

The size of metallic particles after aging remains globally less than or equal to the size of the elementary crystallites of the spinel carrier.

The advantage of developing an ultra-divided carrier to facilitate mechanical anchoring of active phases is demonstrated on these micrographs (FIG. 9a). In this figure, we see that metallic dispersion is better on the ultra-divided deposit than on an alumina grain not coated with the deposit, visible on the photograph on the left. It is impossible to anchor metallic particles mechanically at locations at which there is no deposit and coalescence is natural.

The catalyst according to the invention will preferably be used for Three-Way Catalysts (TWC) in catalytic converters for automobile depollution.

In the framework of this study, the reaction concerns depollution of exhaust gases. This invention may be extended to various applications in heterogeneous catalysis provided that the active phase(s) is (are) adapted to the required catalytic reaction (SMR, chemical, petrochemical, environmental reactions, etc.), on an ultra-divided ceramic catalyst carrier based on spinel, alumina, ceria, zirconia (optionally stabilised with yttrium) or a mix of these compounds.

1-9. (canceled)

10. A device for the purification of exhaust gases from a thermal combustion engine comprising:
one or several ceramic catalyst carriers comprising an arrangement of crystallites of the same size, same isodiametric morphology and same chemical composition, or approximately the same size, same isodiametric morphology and same chemical composition in which each crystallite is in point or quasi-point contact with the surrounding crystallites; the average equivalent diameter of said crystallites being between 2 and 20 nm; and
one or several active phases for chemical destruction of impurities in the exhaust gas comprising metallic particles having chemical interactions with said ceramic catalyst carrier and mechanical anchoring in said catalyst carrier such that coalescence and mobility of each particle are limited to a maximum volume corresponding to the volume of a crystallite of said ceramic catalyst carrier; the average equivalent diameter of said metallic particles being between 2 and 20 nm.

11. The device of claim 10, wherein the arrangement is made of a material selected from the group consisting of: i) alumina (Al₂O₃) or ceria (CeO₂) optionally stabilised with gadolinium oxide; ii) zirconia (ZrO₂) optionally stabilised with yttrium oxide or spinel phase; iii) lanthanum oxide (La₂O₃); and iv) and mixtures of two or more thereof.

12. The device of claim 10, wherein metallic particles are chosen from among:
(i) noble metals selected from the group consisting of Ruthenium, Rhodium, Palladium, Silver, Osmium, Iridium, Platinum, and an alloy of one to three thereof;
(ii) transition metals selected from the group consisting of Nickel, Silver, Gold, Cobalt, Copper, and an alloy of one to three thereof; and
(iii) an alloy of one to three of the noble metals and one to three of the transition metals.

13. The device of claim 10, wherein the chemical interaction is chosen between electronic interactions and/or epitaxy interactions and/or partial encapsulation interactions.

14. The device of claim 10, wherein the average equivalent diameter of the crystallites is between 5 and 15 nm, and the average equivalent diameter of the metallic particles is less than 10 nm.

15. The device of claim 10, wherein the arrangement of crystallites is optimally a compact hexagonal or face-centred cubic stack in which each crystallite is in point or quasi-point contact with not more than 12 other crystallites within a 3-dimensional space.

16. The method for purification of exhaust gases from a thermal combustion engine, comprising circulating exhaust gases through the device of claim 10.

17. The method of claim 16, wherein the thermal combustion engine is an automobile vehicle engine.

18. The method of claim 17, wherein the automobile vehicle engine is a diesel engine.

19. The purification method of claim 17, wherein the automobile vehicle engineis a gasoline engine.
